(19) United States
(12) Patent Application Publication
(10) Pub. No.: US 2013/0047061 A1
(43) Pub. Date: Feb. 21, 2013

(54) Collaborative Content Publishing

(71) Applicants: Ravipal Soin, Kirkland, WA (US); Vinay Krishnaswamy, Woodinville, WA (US); Arjun Taneja, Redmond, WA (US); Anna Mona Latuskiewicz, Kirkland, WA (US)

(72) Inventors: Ravipal Soin, Kirkland, WA (US); Vinay Krishnaswamy, Woodinville, WA (US); Arjun Taneja, Redmond, WA (US); Anna Mona Latuskiewicz, Kirkland, WA (US)

(21) Appl. No.: 13/546,740

(22) Filed: Jul. 11, 2012

Related U.S. Application Data
(60) Provisional application No. 61/525,156, filed on Aug. 18, 2011.

(51) Int. Cl. G06F 17/00

(52) U.S. Cl. 715/205; 715/255; 715/234

(57) ABSTRACT

Disclosed are, among other things, techniques to allow collaborative content publishing with high quality design for users who may or may not have extensive design experience. Flexible formatting may allow many sources of content to be easily used to produce publications with high visual appeal.

### RELATED APPLICATIONS

This application claims priority to provisional application No. 61/525,156 filed Aug. 18, 2011 titled “Method and System for Collaborative Content Publishing and Consumption for Touch Sensitive Devices.”

### FIELD

This disclosure relates to collaborative content publishing.

### BACKGROUND

The internet provides a foundation for people wishing to share pictures, text, multimedia, or other content with others.

It is often easy for an individual to post pictures or write a blog, although producing a well-designed product often requires special skills, which many users do not have.

### SUMMARY

The instant application discloses, among other things, techniques to allow collaborative content publishing with high quality design for users who may or may not have extensive design experience.

As an example, a person (publisher) may want to produce a web-based magazine about their children's soccer team. The magazine may be published weekly, and multiple contributors may submit photos or stories about various players on the team, and the games that they have played. Potential contributors may be invited to submit content for the publication.

A user interface to allowing easy submission for each piece of content may be provided. The publisher may decide to publish, and the submitted content may be formatted with a high quality design and made available for viewing on a web site or a dedicated application made to provide an enhanced experience, or may it be printed. The resulting publication may have different rights to determine who may view it; for example, it may be private, shared with a group, unlisted, or public.

### BRIEF DESCRIPTION OF THE DRAWINGS

FIG. 1 is an example of a system on which Collaborative Content Publishing may be implemented.

FIG. 2 is an example work flow for a creation stage, creating and adding content according to one embodiment.

FIG. 3 is an example of work flow for a review stage, obtaining and reviewing content according to one embodiment.

FIG. 4 is an illustration of automatic attribution tracking according to one embodiment.

FIG. 5 illustrates a component diagram of a computing device according to one embodiment.

### DETAILED DESCRIPTION

A more particular description of certain embodiments of Collaborative Content Publishing may be had by references to the embodiments shown in the drawings that form a part of this specification, in which like numerals represent like objects.

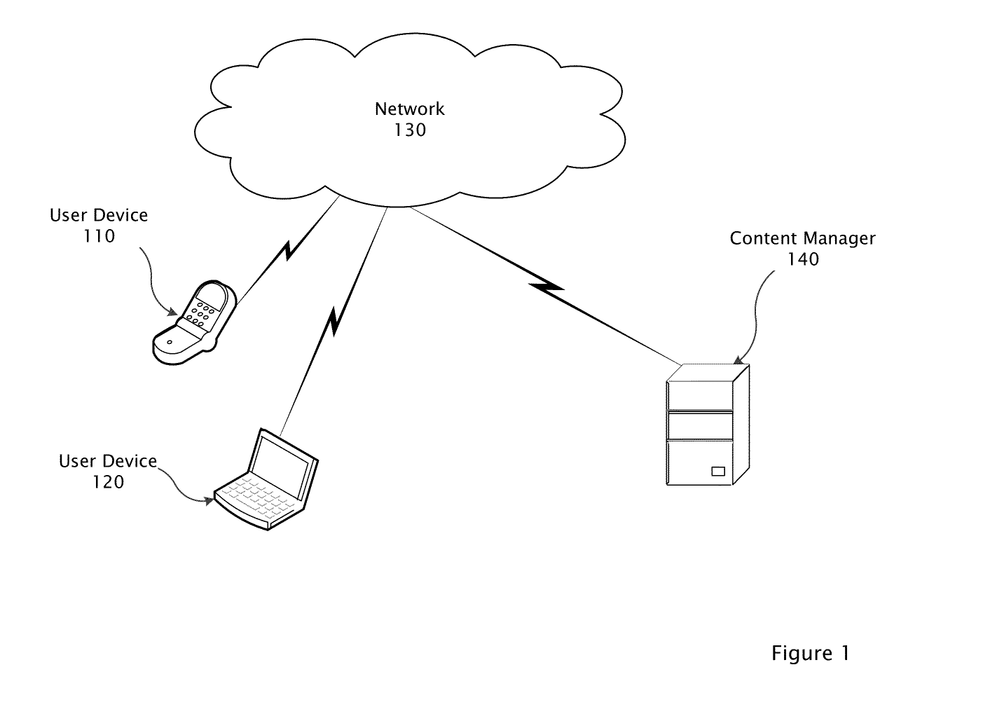

FIG. 1 is an example of a system on which Collaborative Content Publishing may be implemented. In this example, User Device 110 may be used to originate a request for Collaborative Content Publishing and send it via Network 130 to Content Manager 140. Network 130 may be a local area network, or it may include the Internet. Any type of communication link may be used, or all processing may occur on one device. Other types of data transfer may also be used, such as loading information from User Device 110 onto a portable drive and loading the information onto Content Manager 140.

Either User Device 110, User Device 120, or both may be used to upload, review, edit, publish, or view content. These functions may be performed through the use of a web site, through a dedicated application, or through other ways of accessing Content Manager 140.

Content Manager 140 may include one or more computers, and may serve a number of roles, including, but not limited to, storing content and attributes, manipulating content and attributes, and serving content. For example, in one embodiment, Content Manager 140 may include a database with tables to store information about users, user devices, projects, articles, elements, layouts, layout definitions, and other data that may be relevant to Collaborative Content Publishing.

One skilled in the art will recognize that many User Devices 110, 120 may be used during Collaborative Content Publishing, and that both User Devices 110, 120 and Content Manger 140 may be of different designs and capabilities.

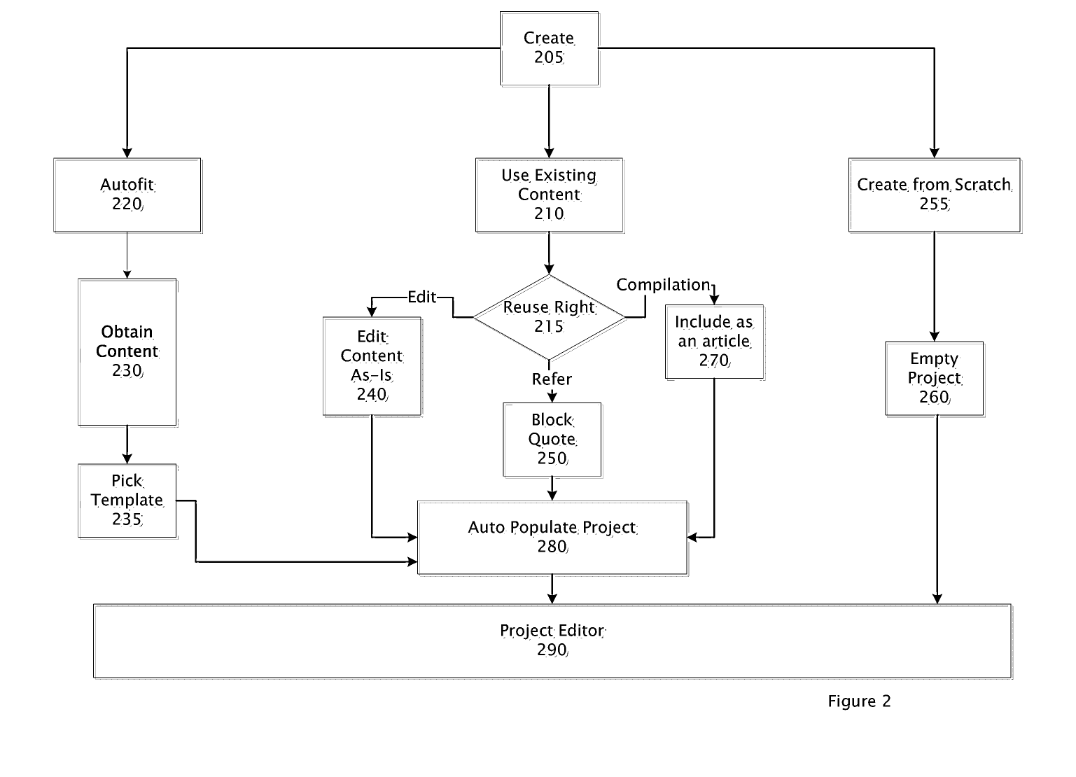

FIG. 2 is an example work flow for a creation stage, creating and adding content according to one embodiment. In this example, a publisher may decide to Create 205 a new publication.

The publisher may decide to Autofit 220 existing content, which may include photos, documents, multimedia, or other content stored locally, for example on User Device 110 or User Device 120. Existing content may also be imported from a web site. For example, Content may be Obtained 230 from a site using a content management system, such as Drupal™, Joomla! ®, or WordPress. Other content may come from a photo-storage site, such as Flickr®, or any other web sites hosting content of interest to the publisher for a project. Websites allowing user updates, such as Facebook™, Twitter™, LinkedIn®, or other websites may also be used. Content may also be obtained from services such as Evernote® that provide access to content on behalf of a user. Content may also be obtained from cloud services, including such providers as iCloud, Dropbox, and Mozy®. The publisher may Pick a Template 235 with which to format the content.

Content created from Scratch 255 may also be generated. This content may be populated directly into the publication from an Empty Project 260.

Existing Content 210 from previous Collaborative Content Publishing projects may be used in various ways. If the author of the original project enabled edit capabilities, users will be able to edit the content. If the author has not enabled editing, relevant sections will automatically be quoted and refer to the original article with attribution to the original author

which may maintain a Reuse Right 215. Content may be Edited As-Is 240, referred to as a Block Quote 250, or added to a compilation and Included as an Article 270. In each of these cases, the Project may be Auto-Populated 280.

Content Edited As-Is 240 may retain formatting such as font families and sizes, paragraphs, list formats, and other attributes from an original source.

In this example, templates may be based upon other web publications, may be based on print magazines, or may be designed for the topic of the target publication. For example, a template may be based on Time®Magazine, or may be designed to produce a celebrity fan webzine. Other examples of designs which may be targeted include magazines, books, coffee table books, and art books, or other publications. One skilled in the art will recognize that there are many possible sources for templates.

One having skill in the art will also recognize that there are many potential sources that may be used to obtain content for a publication.

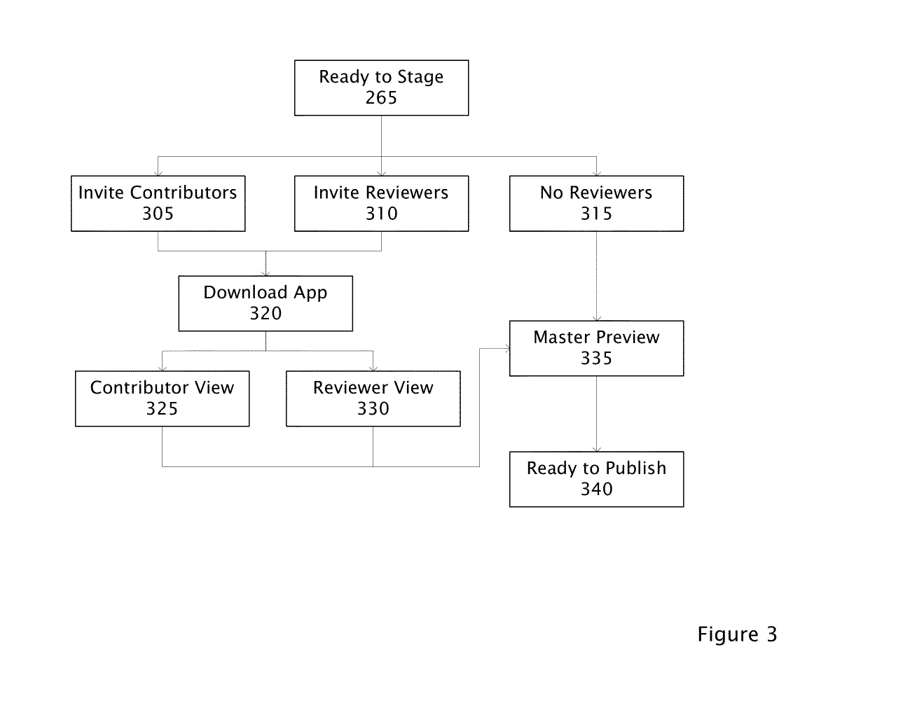

FIG. 3 is an example of work flow for a review stage, obtaining and reviewing content according to one embodiment. Contributors may be Invited 305, using various forms of contact such as Facebook™, Twitter™, LinkedIn®, email, or any other form of contact. Invite Reviewers 310 may be done in similar ways—using any available forms of contact. Invited contributors and reviewers may Download an Application 320 to facilitate their duties. A Contributor View 325 may allow adding content and adding alternative views of content, while a Reviewer View 330 may allow commenting on content.

If No Reviewers 315 are invited, the content may be looked at with a Master Preview 335. A Master Preview 335 may include an ability to perform various activities, including but not limited to editing content, deleting content, adjust layout and style, adjusting formatting, annotating, creating rules for accepting content from contributors, and viewing sources.

The owner of the publication may indicate that the publication is Ready to Publish 340. The publication may be rendered, and made available via one or more of several user interfaces, including but not limited to a web magazine, a reading device such as a Kindle™ or NOOK™, software for viewing the publication on one of various devices such as cell phones, tablets, laptops, or desktop computers. Different devices may provide different experiences for a reader; for example, viewing the publication on software dedicated for Collaborative Content Publishing may provide a richer experience than viewing it as a web magazine.

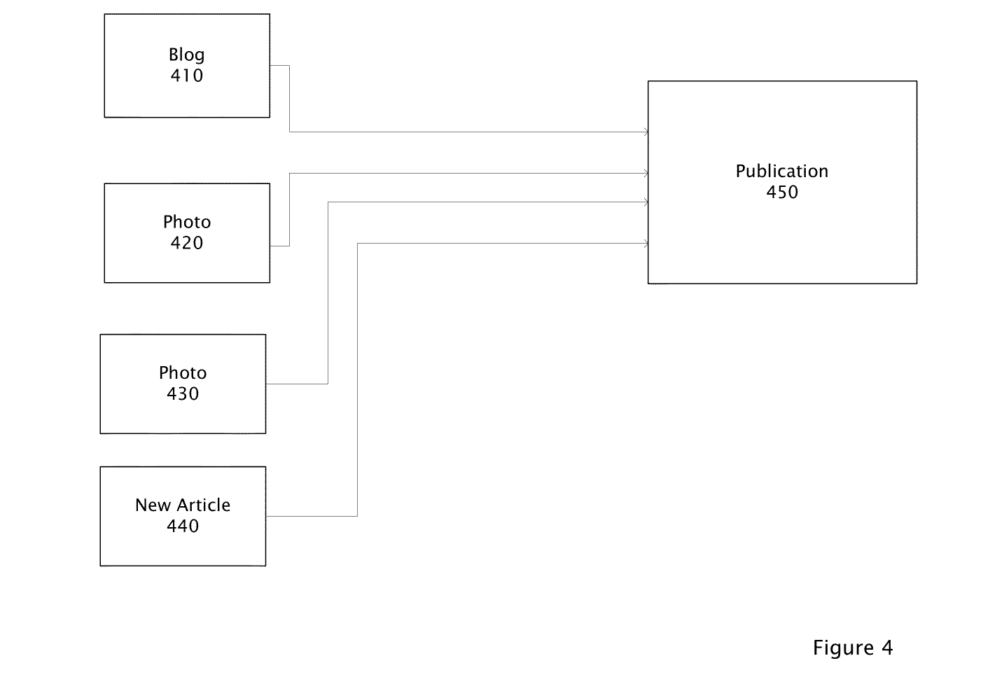

FIG. 4 is an example of automatic attribution according to one embodiment. In this example, content may be added to Publication 450 from Blog 410, Photo 420, Photo 430, and New Article 440.

Existing content may have attribution information that may be associated with it when the content is added. In this example, Blog 410 may have attribution information associated indicating a web site from which it was obtained, and any author, rights, or other information that may be available. Similarly, Photo 420 and Photo 430 may be associated with attribution information appropriate for each of them. New Article 440 may be associated with attribute information identifying the author or owner of the publication.

Attributes may include creation time, updated time, author name, URL, date obtained, copyright information, or other data indicating a source of the content.

In this example, Photo 420 may have been obtained from Facebook. When a user associates this content with a publication, attribution information indicating a time the photo was originally uploaded to Facebook™, a person who uploaded it to Facebook™, where it was on Facebook™, an image file name, and other information may be tracked. This may allow proper credit for the owner of Photo 420 in the publication, or may be used to obtain further content related to a topic.

Again in this example, Photo 430 may have been obtained from a photo website such as Flickr®. Attribution information including an owner name, an upload time, a URL the photo was obtained from, and other information identifying the source of the photo may be tracked. Similarly, Blog 410 may have associated information such as author, date published, URL, copyright information, and other attribution information.

New Article 440 may have attribution information created as it is created, including an author name, creation time, update time, and other attribution information. Attributions may be presented in various dynamic ways depending on the publication.

One having skill in the art will recognize that numerous types of attribution information may be obtained and may vary by the source of the content.

In at least one embodiment, the publisher may update the attribution information.

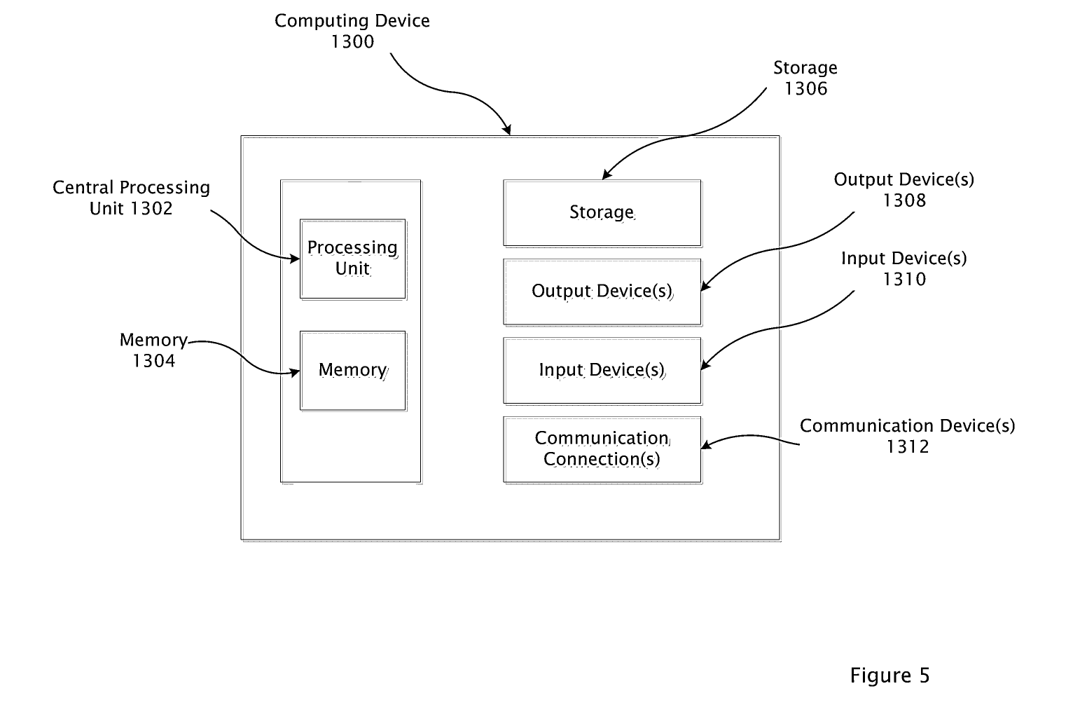

FIG. 5 illustrates a component diagram of a Computing Device according to one embodiment. The Computing Device (1300) can be utilized to implement one or more computing devices, computer processes, or software modules described herein, including, for example, but not limited to User Device 110, 120 or a Content Manager 140. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by a User Device 110, 120 or a Content Manager 140. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer storage media includes volatile and nonvolatile, removable and non-removable media implemented in any method or technology for storage of information such as computer readable instructions, data structures, program modules or other data. Memory (1304) and Storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A system, comprising:
a processor;
a memory coupled to the processor;
a content receiving module, configured to receive content from a plurality of user devices;
an attribution tracking module, configured to track attribution information for received content;
a template management component configured to allow selection of a template for a publication;
an autofit component configured to automatically place and format received content into a selected template;
a rendering component configured to render output from the autofit component.

2. The system of claim 1, further comprising a user account management component, configured to allow creation, editing, and deletion of user accounts.

3. The system of claim 1 further comprising a database component configured to store and retrieve received content.

4. The system of claim 1 further comprising an access rights component, configured to allow selection of one or more access rights permitted for one or more users.

5. The system of claim 1 wherein the selection of a template comprises choosing from a list of templates based on one or more publications selected from a group comprising print magazines, books, web magazines, blogs, coffee table books, and art books.

6. The system of claim 1 wherein rendering output comprises generating a format selected from a group comprising generating HTML code, preparing output for viewing on software dedicated to viewing output from the system, and preparing output for a reader device.

7. A method, comprising:
receiving a first piece of content from a first user device;
receiving a second piece of content from a second user device;
formatting the first piece of content and the second piece of content; and
rendering an output based on the formatted content.

8. The method of claim 7 wherein the first piece of content comprises content selected from a group comprising a web link, a picture file, a text file, a word processing file, a slide show file, a video file and a spreadsheet file.

9. The method of claim 7 wherein the formatting comprises:
selecting a template to format the first piece of content and second piece of content; and
automatically placing the first piece of content and second piece of content in the selected template.

10. The method of claim 9 wherein the selecting a template comprises choosing from a list of templates based on print magazines.

11. The method of claim 7 wherein the formatting comprises:
selecting a template to format the first piece of content and second piece of content; and
manually placing the first piece of content and second piece of content in the selected template.

12. The method of claim 9 wherein the selecting a template comprises choosing from a list of templates based on one or more publications selected from a group comprising print magazines, books, web magazines, blogs, coffee table books, and art books.

13. The method of claim 7 wherein the rendering comprises producing HTML script.

14. A computer readable storage media containing instructions thereon which, when executed, perform a method comprising:
receiving a first piece of content from a first user device;
receiving a second piece of content from a second user device;
formatting the first piece of content and the second piece of content; and
rendering an output based on the formatted content.

15. The method of claim 14 wherein the formatting comprises:
selecting a template to format the first piece of content and second piece of content; and
automatically placing the first piece of content and second piece of content in the selected template.

16. The method of claim 14 wherein the formatting comprises:
selecting a template to format the first piece of content and second piece of content; and
manually placing the first piece of content and second piece of content in the selected template.

17. The method of claim 14 wherein the rendering comprises generating a format selected from a group comprising generating HTML code, preparing output for viewing on software dedicated to viewing output from the system, and preparing output for a reader device.
